(19) United States
(12) Patent Application Publication
(10) Pub. No.: US 2009/0225529 A1
(43) Pub. Date: Sep. 10, 2009

(54) Spherically emitting remote phosphor

(75) Inventors: Waqidi Falicoff, Stevenson Ranch, CA (US); Julio C. Chaves, Madrid (ES)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: LIGHT PRESCRIPTIONS INNOVATORS, LLC, Altadena, CA (US)

(21) Appl. No.: 12/378,666

(22) Filed: Feb. 18, 2009

Related U.S. Application Data
(60) Provisional application No. 61/066,528, filed on Feb. 21, 2008.
(60) Provisional application No. 61/125,844, filed on Apr. 29, 2008.

(51) Int. Cl. F21V 9/16

(52) U.S. Cl. 362/84

(57) ABSTRACT

Light sources comprise an emitter of photostimulative light, such as one or more blue LEDs, a reflector, which may be a diverging cone, disposed to reflect light from the LEDs towards an exit aperture, a tailored aspheric lens that further collimates the light from the reflector, a short-pass filter receiving and transmitting the collimated light, a dielectric concentrator receiving the light transmitted by the filter from the LEDs and concentrating it upon the exit aperture, a dielectric emission optic on the outside of the exit aperture to receive the concentrated light, and a layer of photosensitive phosphor deposited on the outside of the emission optic, the phosphor responsive to the LED light to emit light of a longer wavelength.

### CROSS REFERENCE TO RELATED APPLICATION

This application claims benefit of U.S. Provisional Patent Application No. 61/066,528, filed Feb. 21, 2008 in the names of Falicoff and Chaves, and U.S. Provisional Patent Application No. 61/125,844, filed Apr. 29, 2008 in the names of Falicoff and Chaves, which are incorporated herein by reference in their entirety.

### BACKGROUND OF THE INVENTION

White light-emitting diodes (LEDs) seem destined to become the major type of new lighting, due to their high luminous efficacy, long life, and rugged compactness. Because the actual emitter within the LED's semiconductor chip is always a very thin interface layer, LED chips are predominantly planar emitters. White LEDs of the prior art comprise a thin phosphor layer deposited over the blue-emitting chip, so that they too are planar emitters. In general lighting, however, there is often a requirement for the spherical emission of conventional incandescent bulbs. U.S. Pat. No. 7,021,797 by Minano et. al. disclosed numerous configurations with spherical emission, and it is incorporated herein in its entirety. One such is shown in FIG. 3 herein, for comparison with the present invention. In general, “spherical” does not require a complete sphere, which is in most cases impractical, but it is typically desired to cover about as much of a sphere as is illuminated by a conventional incandescent bulb.

### SUMMARY OF THE INVENTION

The remote phosphor concept utilized in the present devices is that of U.S. Pat. No. 7,286,296 by Chaves et. al, which is incorporated herein by reference in its entirety, as well as associated CIP U.S. Patent Application No. 2006/0239006, which is incorporated herein by reference in its entirety. The blue LED has a collimating optic which shines its light through a blue-pass filter that has high yellow-reflectivity. A concentrating optic puts all this photostimulative blue light onto a small phosphor patch, which emits yellow light both outward and back towards the filter. This yellow back-emission is returned to the phosphor by the filter, thereby increasing its luminance and the system's efficiency. The collimator is necessary because the filter only passes blue light that is near normal incidence, typically within a cone of approximately 15°. The concentrator is necessary else the phosphor must cover the entire filter, greatly increasing its étendue.

In one embodiment of the present devices, the concentrator is dielectric-filled (refractive index n), making its small end n² times smaller in area than the entrance aperture of a corresponding air-filled concentrator. This approach to reducing the exit aperture of the phosphor target relative to the source area was mentioned in the paper, “Performance and trends of High power Light Emitting Diodes”, by Bierhuizen et al, in the 2007 proceedings of the SPIE in Vol. 6669. The authors reported a small increase in the luminance but the efficiency of the device was not any better than a conformal phosphor coated LED. They employed a planar phosphor patch at the end of the solid dielectric CPC, as does the earlier remote phosphor systems of the same configuration (collimator/short-pass filter/concentrator) in above-mentioned U.S. Pat. No. 7,286,296. Also, it was pointed out in U.S. Pat. No. 7,286,296 that a planar phosphor patch in such a remote phosphor configuration will send the majority (50 to 65%) of its yellow light back towards the filter. The general equations that predict the efficiency for such remote phosphor systems are provided in the above-mentioned US Application No. 2006/0239006. In particular, a key parameter that determines the performance of a remote phosphor system was therein called P_{T} and was defined as the fraction of the light striking the phosphor patch 6205 that is further transmitted out the front of phosphor on each pass. It can be seen from the general equations in this application that the higher the value of P_{T} the higher the efficiency of a system. This is also illustrated in FIG. 62c of that application, which shows the results of one computer simulation. Graph 6250 has horizontal axis 6251 enumerated with a values of P_{T} and vertical axis 6252 enumerated with values of color-independent extraction efficiency η_{E}=L_{O}/L. It is clear that it is important to have a high value of P_{T}, otherwise the efficiency of a remote phosphor system is no better than that of a conventional white LED.

In the present application the blue light passes through the small end of the dielectric concentrator and enters a sphere or other volumetric shape, which may be referred to generally as a “ball,” with the phosphor deposited on its-external surface. The increase in surface area of the phosphor on the volumetric shape increases the étendue of the emitting surface relative to the étendue of the small end of the dielectric concentrator. This increases the P_{T} of the system roughly in proportion to the ratio of the two areas. For example, if the end of the concentrator is circular and the volumetric shape is a hemisphere having the same diameter as the circle, the surface area bearing the phosphor will be twice the area of the circular end of the dielectric concentrator. If the dielectric concentrator has an index of refraction of 2 then the small end of the dielectric concentrator could be 4 times (n²) smaller than the entrance of the collimator (assuming it is an open reflector). If there was a hemispherical solid dielectric on the exit aperture of the concentrator (hereafter known as a dielectric emitting optic) having the same diameter as the circle, the area of the hemisphere will be twice that of the circle. In a perfect system this will increase the luminance by a factor of two (4/2). However, because there is a significant increase in the value of P_{T} (the surface area of the phosphor is twice the area of the small end of the concentrator), the system will have improved efficiency. Therefore, this new approach can achieve a very high efficiency with little or no increase in étendue (in some designs a reduction in étendue is possible).

There is another advantage to the new approach, in that it is possible to emit light into a solid angle much greater than an LED light source, which is typically limited to 2π steradian (a hemisphere), but with intensity diminishing to zero at the horizontal. A phosphor-coated sphere will radiate much like a light bulb, with nearly 4π steradian emission (a complete sphere, except for shadowing by the light bulb's opaque base). Even a phosphor-coated hemisphere will emit into a substantially large solid angle. Also, most of its emission back into the sphere will self-intersect, greatly enhancing efficiency and uniformity of the output, since the device operates much like an integrating sphere. It was determined by the inventors that a preferred dielectric emitting optic (as shown in FIG. 5A) with a phosphor layer of 100 microns thick and having a bulk scattering coefficient of 100/mm, provides sufficient mixing to homogenize the image of a square LED source and produce a near perfect spherical pattern in all directions (except back toward the source). This spherical pattern from the preferred embodiment is shown in FIG. 5B.

To save cost, the collimator can be a simple cone in order to take advantage of highly efficient thin films sold on rolls, such as the dielectric reflectors of the 3M Corporation. The developable surface of the cone makes it much easier to fashion out of flat material than any curved-profile conicoid. Instead of a tailored collimator for the blue LED, this simple cone is used with a novel kind of dielectric concentrator, as disclosed herein. The profile of its curved sidewalls is tailored to work with the conical reflector to attain étendue-limited concentration of the blue light at the small end of the concentrator. Recently developed moldable glasses are now available at n=1.8 (that of the phosphor) as well as even higher. For example, OHARA of Japan is marketing its PBH55 glass, having an index of 1.84 in the visible spectrum and a very high transmittance (over 99% transmittance for a 10 mm path length.). Thus this tailored concentrator will be quite compact and highly efficient. Other dielectric concentrators can also be employed in this system, particularly solid dielectric compound parabolic concentrators (CPCs) and compound elliptical concentrators (CECs). In the case of the CPC and CEC dielectric concentrators, a preferred collimator is a combination of a cone and an inverted plano-convex lens (which can advantageously be spherical). In addition, the collimator can be an open CPC, CEC or other optical device known to those skilled in the design of non-imaging optics.

### BRIEF DESCRIPTION OF THE DRAWINGS

The above and other aspects, features and advantages of the present invention will be apparent from the following more particular description thereof, presented in conjunction with the following drawings wherein:

FIG. 1 shows a cross section of a spherically emitting light source with a spherical dielectric emitting optic.

FIG. 2 shows a cross section of a light source having a conical dielectric emitting optic.

FIG. 3 shows a preferred embodiment from U.S. Pat. No. 7,021,797.

FIG. 4 shows a CEC-based light source.

FIG. 5A shows a light source with a cone, an SMS lens, and a solid dielectric light source.

FIG. 5B shows the spherical emission of the light source of FIG. 5A, with a nearly fully spherical phosphor emitting ball.

FIG. 5C shows the spherical emission of a light source similar to that of FIG. 5A, but with a hemispherical phosphor emitter.

FIG. 5D shows the spherical emission of a light source similar to that of FIG. 5A but with a conical phosphor emitter.

FIG. 6 shows a light source having a square angle-transformer with CPC.

FIG. 7 is a diagram of a spherical remote phosphor.

FIG. 8 is a graph of remote phosphor performance.

### DETAILED DESCRIPTION OF THE PREFERRED EMBODIMENTS

A better understanding of the features and advantages of the present invention will be obtained by reference to the following detailed description of embodiments of the invention and accompanying drawings, which set forth illustrative embodiments in which some of the principles of the invention may be utilized.

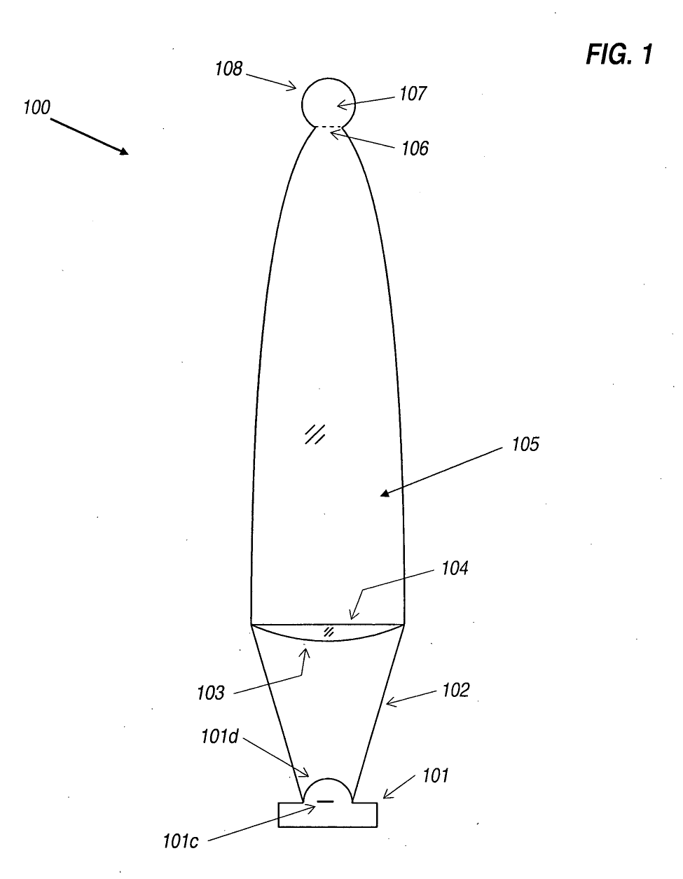

FIG. 1 shows a cross-section of an embodiment of a light source 100, comprising LED package 101, conical reflector 102, plano-convex lens 103, blue-pass filter 104, dielectric concentrator 105, and dielectric emitting spherical ball 107. Package 101 comprises emitting chip or chips 101c and transparent dome 101d, which could as well be a flat window, if the highest possible luminance is desired (admittedly at the cost of some flux loss). In one embodiment, conical reflector 102 comprises a reflective sheet of flat material, rolled into a cone, with the reflecting side on the interior surface. In an alternative embodiment that may be preferred for high-power implementations, the conical reflector 102 could be heavier, a casting of a material and of a suitable design so as to act as a heat-sink, as exemplified in FIGS. 72A and 72B of US 2006/0239006. The bottom end of reflector 102 opens sufficiently to admit dome 101d. The top end wraps about the perimeter of filter 104, directing all light from chip 101c onto lens 103, through which the light passes and encounters filter 104. The blue emission color of chip 101c ensures the light passes through filter 104 and into concentrator 105, which sends all the light on to the upper end, denoted by dotted line 106.

Dotted line 106 may represent a purely notional boundary if concentrator 105 and ball 107 are made in a single piece, could be the glue line, weld line, or the like for bonding, fusing, or otherwise joining a separate ball 107 to concentrator 105. In the embodiments, concentrator 105 and ball 107 have the same refractive index n, and any join at line 106 is sufficiently continuous that deflection and absorption of light rays at line 106 are negligible. The refractive index n of concentrator 105 causes line 106 to be n times smaller than the diameter of dome 101d. This concentrated light passes into ball 107 and strikes the phosphor coating 108 on the surface of the ball. Both the blue absorptivity and scattering of coating 108 are tailored to ensure that its luminance and color temperature appear uniform from different directions. Filter 104 could either be a separate part or be incorporated onto the flat surface of lens 103 or the large flat surface of concentrator 105. The area of the upper aperture of concentrator 105, designated by dotted line 106, can be n smaller than the area of entrance aperture of cone 102. This can, however, be made larger if maximum luminance is not required. In this case the solid dielectric can be shortened, making the overall system more compact.

This design can also be easily modified to handle a number of LEDs or LED chips. In order to achieve maximum luminance, it is desirable that the chips fully flash the entrance aperture of cone 102. Suitable LEDs are made by OSRAM Semiconductor under the brand name OSTAR. These are typically available in arrays of four or six emitting chips. Given sufficient production resources, however, it is possible to produce them in hexagonal or octagonal configurations to better pack the circular opening of the entrance aperture of cone 102.

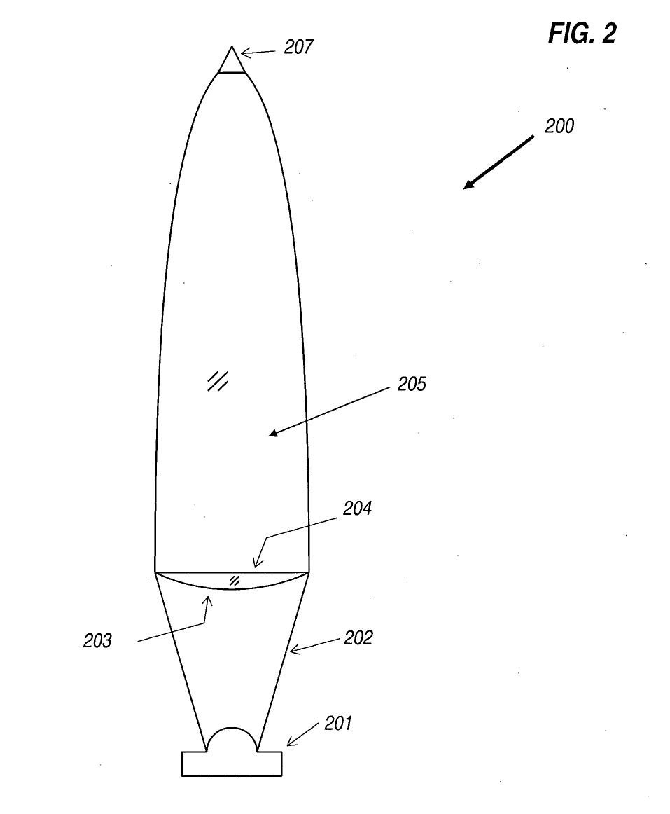

FIG. 2 shows an alternative embodiment of light source 200, comprising LED package 201, conical reflector 202, tailored plano-convex lens 203, blue-pass filter 204, dielectric concentrator 205, and emitting ball in the form of cone 207, which emits isotropically into the hemisphere of upward directions, with minor emission downward.

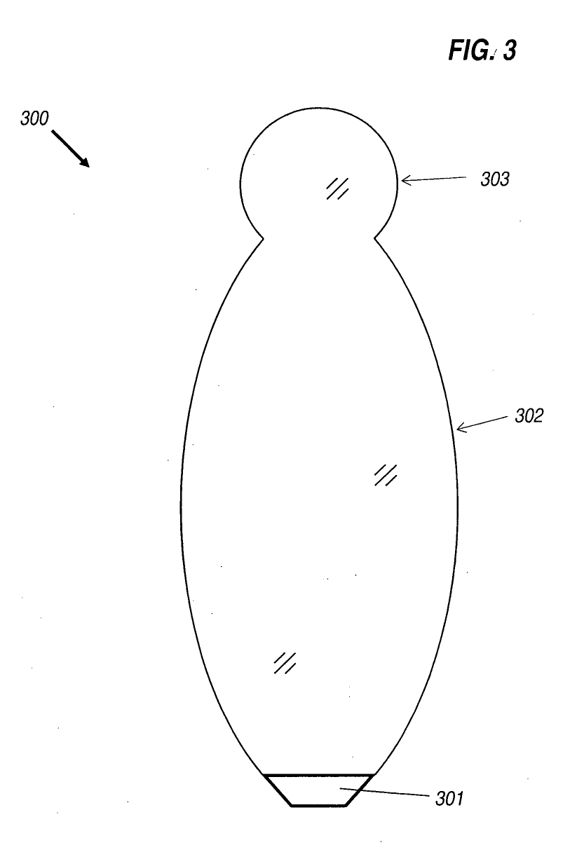

FIG. 3 reprises a preferred embodiment of U.S. Pat. No. 7,021,797. Light source 300 comprises RGB LED 301, compound elliptical concentrator 302, and diffusely-scattering ball 303, from which light is emitted in all directions.

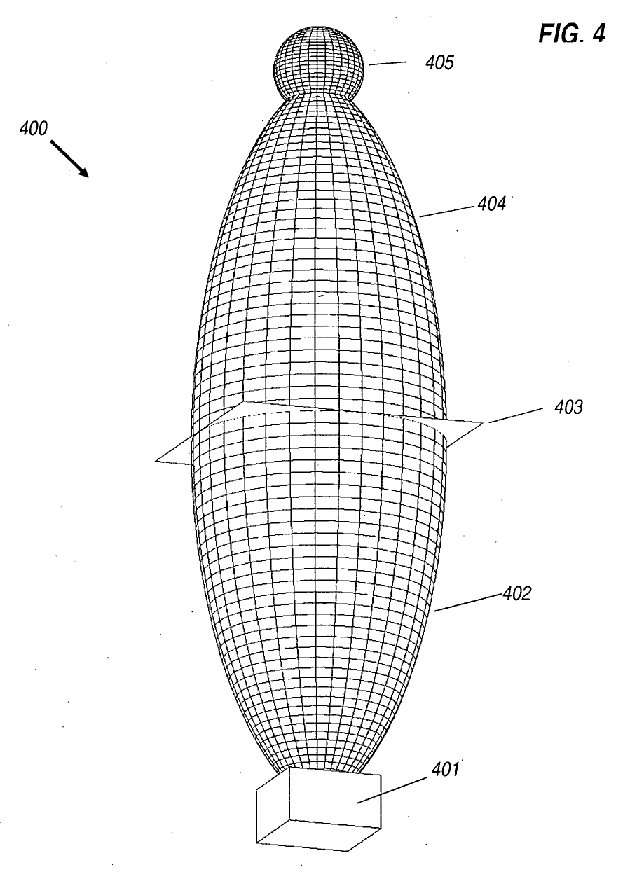

FIG. 4 is a perspective view from below of an embodiment of a light source 400, comprising LED package 401, lower dielectric compound elliptical reflector 402, blue-pass filter 403 (shown rectangularly protruding for the sake of visibility, rather than the actual circle it would be), upper dielectric compound elliptical concentrator 404, and phosphor coated ball 405. The overall shape of light source 400, an off-axis ellipsoid, somewhat resembles the elongated incandescent chandelier-bulb that it could replace, but is more symmetric. The bulb's shape, however, was not functional but merely meant to resemble a flame. In the case of light source 400, only the phosphor-coated ball 405 emits light. The surface area of the ball is 3.4 times that of the exit of concentrator 404, but its overall spherical shape gives it nearly constant intensity down to a direction well below horizontal as oriented in FIG. 4.

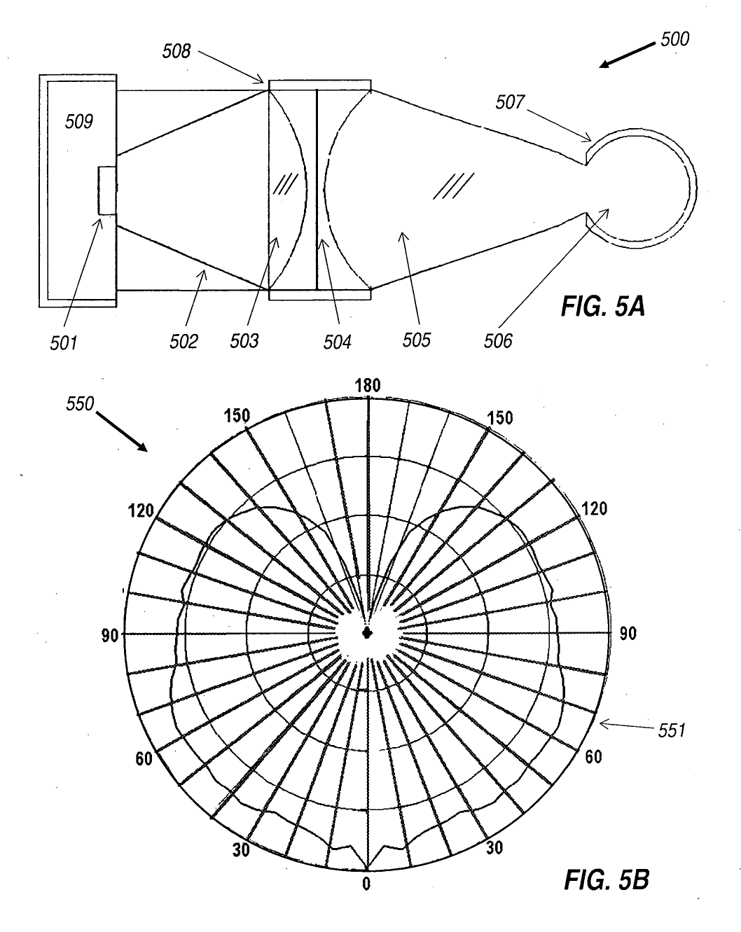

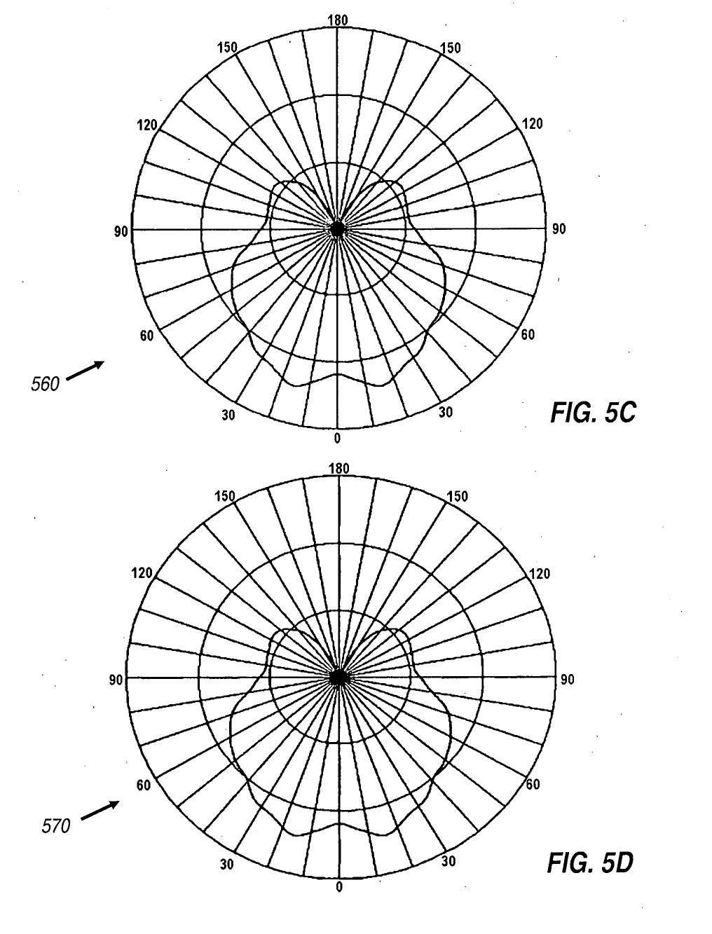

FIG. 5A shows a further embodiment of a light source 500, comprising LED 501, conical reflector 502, aspheric convex-convex lens 503, blue-pass filter 504, tailored dielectric concentrator 505, contiguous ball 506, phosphor-coating 507, external shroud and support structure 508, and power electronics compartment 509 with heat-sink (not shown). With LED 501 at 1 mm in width, the entirety of light source 500 has a length of merely 8 mm, sufficiently diminutive to replace small incandescent bulbs, at much higher luminous efficacy. Lens 503 is designed by the simultaneous multiple surface method of U.S. Pat. No. 6,639,733, specifically so that reflector 502 can be a simple cone. This design method couples wavefronts from the opposite edges of the source into a pair of desired output wavefronts. The rays comprising the wavefronts emitted by the edges of the source are called edge rays. Dielectric concentrator 505 has nearly conical sidewall with shape tailored for its front convex surface to be spherical, a far easier and more accurate shape to make than any asphere. The conical shape of open reflector 502 is also easier for manufacturing. Dielectric concentrator 505 can be molded and can be made of glass or plastic. It is also possible to mold dielectric concentrator 505 and contiguous ball 506 as one piece. Phosphor coating 507 can be deposited by a number of methods known to those skilled in the art. One approach that is suitable for volume production is the electrophoretic deposition process (the migration of charged colloidal particles or molecules through a solution under the influence of an applied electric field usually provided by immersed electrodes, also called cataphoresis). This process is described in U.S. Pat. No. 6,576,488.

This deposition technique requires that the substrate have a thin layer of electrically conductive material. This can be done using well-established thin film coating techniques such as sputtering or vapor deposition. This coating can be a single layer material or can comprise several layers, as long as the layer in contact with the phosphor is conductive. The multi-layer coating can be designed to increase the transmittance of light from ball 506 to phosphor coating 507. One such candidate electrical conductive material is Indium Tin Oxide. It can be deposited with an index of refraction ranging from 1.7 to 2.0. The lower value would be beneficial as the index of refraction of phosphors such as YAG commonly used in conjunction with LEDs is approximately 1.8. Indium Tin Oxide has successfully been deposited on a range of plastics and glass.

An example of the spherical emission of light source 500 is displayed in FIG. 5B, showing polar intensity graph 550, comprising a full circle of directions for the output graph line 551. It can be seen to be relatively constant from the forward direction 0° (on axis) to 130°, falling to half at 160°. This is actually more uniform than most unfrosted incandescent bulbs and even some frosted ones. The half opening angle of contiguous ball 506 of FIG. 5A is approximately 155° (310° full angle). FIG. 5C shows an example of the spherical emission 560 of light source 500 when the 155° half-angle opening of contiguous ball 506 is replaced with a hemispherical ball (opening half angle is 90°). FIG. 5D shows spherical emission 570 of light source 500 with a conical emitter, where the height of the cone is π times the radius of exit aperture of dielectric concentrator 505 of FIG. 5A. This makes the projected area of the cone viewed from the side be the same as the area of the exit aperture 106 of dielectric concentrator 505. Phosphor coating 507 is deposited on the cone, which is a solid dielectric optic. As seen in the polar isocandela plot of FIG. 5D, this cone height results in nearly equal intensities in the 0° angular direction and at 90°.

The following Tables provide a prescription for all the optical components for the preferred embodiment of the optical system of FIG. 5A but set to an arbitrary scale. The values in the Tables can be scaled to produce the desired size optic in proportion to the dimensions of the light source. The coordinates for each profile are cylindrical polar coordinates, listed as (x,z) pairs where z is a longitudinal position measured along the optical axis and x is a radius measured perpendicular to the axis. Z is measured from the widest points of the collimator/lens 502/503 and of the concentrator 505, with the positive direction in each case being towards the filter 504. The axial length of the space around filter 504, between the exit surface of lens 503 and the entrance surface of concentrator 505, is relatively non-critical, because the light in that region is largely collimated. The resulting profiles are then rotated 360° to create three dimensional surfaces. The end walls of the Cone are shown in Table 1.

TABLE 1
End Points of Cone 502

| x | z |
|---|---|
| 1 | 0 (Lens Position) |
| 0.342020143 | −1.482896468 (LED position) |

TABLE 2
Entrance (LED-Side) Surface of SMS Lens 503

| X | z | x | z |
|---|---|---|---|
| 1 | 0 (Rim of lens) | 0.557178902 | −0.012469987 |
| 0.999898362 | −2.7711E−06 | 0.544802679 | −0.012789168 |
| 0.989811759 | −0.00027866 | 0.532521316 | −0.013102007 |
| 0.979724585 | −0.000556241 | 0.52033567 | −0.01340839 |
| 0.969707669 | −0.000833462 | 0.50824654 | −0.01370822 |
| 0.959592354 | −0.00111491 | 0.496254661 | −0.014001408 |
| 0.948990598 | −0.001411418 | 0.484360709 | −0.014287876 |
| 0.938701826 | −0.00170057 | 0.472565298 | −0.014567557 |
| 0.92818846 | −0.001997356 | 0.458918443 | −0.01488545 |
| 0.917056405 | −0.002312951 | 0.443479566 | −0.015237444 |
| 0.906898034 | −0.002602047 | 0.428219373 | −0.015577069 |
| 0.896340827 | −0.002903508 | 0.413138686 | −0.01590428 |
| 0.886220791 | −0.00319336 | 0.398238153 | −0.01621906 |
| 0.876127612 | −0.0034832 | 0.38351825 | −0.016521419 |
| 0.866062063 | −0.003772906 | 0.368979286 | −0.016811396 |
| 0.85545582 | −0.004078786 | 0.354621413 | −0.017089054 |
| 0.844324229 | −0.004400371 | 0.340444625 | −0.01735448 |
| 0.83322982 | −0.004721324 | 0.326448767 | −0.017607784 |
| 0.82217361 | −0.005041482 | 0.310335786 | −0.017888376 |
| 0.811144418 | −0.00536104 | 0.292211142 | −0.018189512 |
| 0.799421204 | −0.005700766 | 0.274406118 | −0.018469997 |
| 0.787745027 | −0.006039038 | 0.256918876 | −0.01873029 |
| 0.776117047 | −0.006375675 | 0.239747218 | −0.018970893 |
| 0.764538402 | −0.006710494 | 0.222888609 | −0.019192345 |
| 0.753958291 | −0.007015973 | 0.206340206 | −0.019395215 |
| 0.742461557 | −0.007347274 | 0.190098885 | −0.019580097 |
| 0.73101749 | −0.007676249 | 0.174161261 | −0.019747606 |
| 0.719627137 | −0.008002734 | 0.15852372 | −0.019898371 |
| 0.708291518 | −0.008326568 | 0.140639975 | −0.020054069 |
| 0.697011626 | −0.008647597 | 0.130593785 | −0.020133622 |
| 0.685788427 | −0.008965671 | 0.110886233 | −0.020272976 |
| 0.670893445 | −0.009385498 | 0.09168318 | −0.020387276 |
| 0.656103445 | −0.009799466 | 0.072973971 | −0.020478046 |
| 0.641420399 | −0.010207261 | 0.054747653 | −0.020546786 |
| 0.626846276 | −0.010608588 | 0.036993039 | −0.020594959 |
| 0.612382949 | −0.011003168 | 0.019698785 | −0.020623986 |
| 0.598032194 | −0.011390739 | 0.002853439 | −0.020635239 |
| 0.582212188 | −0.011813092 | 0 | −0.020635239 (Pole) |
| 0.569649066 | −0.012144583 | | |

TABLE 3
Exit (Emitter side) Surface of SMS Lens 503

| X | z | x | z |
|---|---|---|---|
| −1 | 0 (Rim of lens) | −0.588700169 | 0.243088814 |
| −0.999902866 | 7.53985E−05 | −0.577976242 | 0.247558285 |
| −0.99195404 | 0.006213805 | −0.567287363 | 0.251925358 |
| −0.983882566 | 0.012383051 | −0.553073481 | 0.257597478 |
| −0.975516954 | 0.018709662 | −0.538929528 | 0.263089321 |
| −0.967258516 | 0.024888342 | −0.524859371 | 0.26840249 |
| −0.958834237 | 0.031123108 | −0.510866859 | 0.273538693 |
| −0.950550873 | 0.037187091 | −0.496955695 | 0.278499787 |
| −0.942300405 | 0.04316189 | −0.483129428 | 0.28328777 |
| −0.933782716 | 0.049262495 | −0.469391455 | 0.287904772 |
| −0.925243221 | 0.055310123 | −0.455745015 | 0.292353047 |
| −0.916353244 | 0.06153348 | −0.442193191 | 0.296634965 |
| −0.907442058 | 0.067697977 | −0.428738904 | 0.300753 |
| −0.898082668 | 0.074093616 | −0.410931788 | 0.306000323 |
| −0.889546588 | 0.079856625 | −0.393309763 | 0.310966417 |
| −0.880994458 | 0.085563904 | −0.375878302 | 0.315657952 |
| −0.872427332 | 0.091214796 | −0.35864254 | 0.320081763 |
| −0.863270533 | 0.097181623 | −0.341607122 | 0.324244863 |
| −0.854089724 | 0.103088826 | −0.32477621 | 0.328154415 |
| −0.844895632 | 0.108929518 | −0.308153494 | 0.331817696 |
| −0.835689577 | 0.11470302 | −0.291742205 | 0.33524207 |
| −0.826472882 | 0.120408682 | −0.275545131 | 0.338434955 |
| −0.816473367 | 0.126515153 | −0.259564627 | 0.341403802 |
| −0.807226042 | 0.132085129 | −0.24901761 | 0.34326478 |
| −0.797972175 | 0.137585278 | −0.238568656 | 0.345031413 |
| −0.78871311 | 0.143015082 | −0.228217979 | 0.346705945 |
| −0.779450191 | 0.148374062 | −0.217965907 | 0.348290573 |
| −0.770184762 | 0.153661769 | −0.207812698 | 0.349787484 |
| −0.760918166 | 0.158877791 | −0.197758539 | 0.351198851 |
| −0.749581266 | 0.165161313 | −0.187803551 | 0.352526829 |
| −0.737212346 | 0.171894777 | −0.168191259 | 0.354941149 |
| −0.724849814 | 0.17849834 | −0.148975552 | 0.35704728 |
| −0.712496812 | 0.184971413 | −0.130155257 | 0.358861676 |
| −0.700156458 | 0.191313518 | −0.111728367 | 0.360400356 |
| −0.687831843 | 0.197524287 | −0.093692125 | 0.36167887 |
| −0.675526022 | 0.203603462 | −0.076043095 | 0.362712262 |
| −0.664590596 | 0.208903848 | −0.055920686 | 0.363628033 |
| −0.653674656 | 0.214099767 | −0.044647408 | 0.364018947 |
| −0.64278018 | 0.219191301 | −0.033540993 | 0.364318342 |
| −0.631909212 | 0.224178545 | −0.022599852 | 0.3645301 |
| −0.621063765 | 0.229061663 | −0.011822317 | 0.364657989 |
| −0.610245819 | 0.23384088 | −0.001206654 | 0.364705668 |
| −0.599457318 | 0.238516481 | 0 | 0.364705668 (Pole) |

Tables 2 and 3 list the coordinate points for two SMS lens profiles. The well established spline approximation can be used to fill the curve between the points. This was done by the inventors using the ACIS Scheme routine in the raytracing package TracePro. This was used to produce the design of FIG. 5A.

The front convex surface of the DTIRC concentrator optic 505 has a spherical profile. The center of the spherical profile is given in Table 5, with z=0 at the widest point of concentrator 505. The radius of the sphere is 1.305.

TABLE 4
Center of spherical inlet surface of DTIRC optic 505

| x | z |
|---|---|
| 0 | −0.839099631 |

TABLE 5
Outside of DTIRC optic 505

| X | z | x | z |
|---|---|---|---|
| 1 | 0 (wide end) | 0.441380145 | −1.613481572 |
| 0.862047184 | −0.370961702 | 0.413299528 | −1.689829471 |
| 0.777953048 | −0.605928623 | 0.385866734 | −1.760718715 |
| 0.718139151 | −0.779011514 | 0.359178318 | −1.82593395 |
| 0.670854171 | −0.919911271 | 0.333406992 | −1.885297591 |
| 0.630631033 | −1.042417203 | 0.308797677 | −1.93868315 |
| 0.594651234 | −1.153446259 | 0.285662164 | −1.986014767 |
| 0.561352514 | −1.256562067 | 0.264370596 | −2.027255935 |
| 0.529822757 | −1.353557203 | 0.245338208 | −2.062389826 |
| 0.499512797 | −1.445246031 | 0.229005787 | −2.091393446 |
| 0.470093045 | −1.531896651 | | (narrow end) |

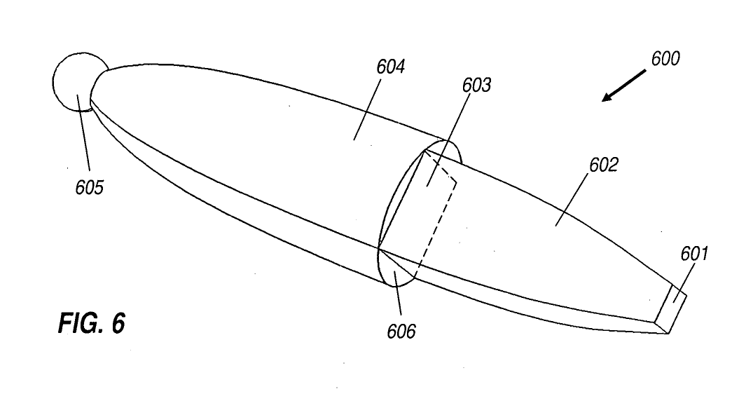

FIG. 6 shows an embodiment of a remote phosphor optical system 600, comprising input plane 601 for receiving blue light from a planar-window top-emitting LED package, square angle transforming optic 602, blue-pass yellow-reflecting square filter 603 at the exit aperture of optic 602, round concentrating optic 604, and phosphor coated spherical end-cap 605. Concentrating optic 604 is round in order to transition to a sphere, as well as for efficient recycling, so that a residual mirror 606 is necessary to complete the recycling by square filter 603. Angle transforming optic 602 can be designed to be in contact with the top-emitting LED package or, preferably, there is an air-gap between the LED package and optic 602. In the latter case, the acceptance angle at the base of angle transforming optic 602 depends on the index of refraction of the material. In order to achieve a coupling efficiency of above 98% the distance between the base of optic 602 and the top face of the LED package should be on the order of 10 to 15 microns. In a preferred embodiment the dimension of the side of optic 602 should be approximately 200 microns larger than the side of the emitting surface of the LED package. For example, if the side dimension of the emitting surface of the LED package is 1000 microns, the side of optic 602 at its base should have a dimension of 1200 microns. This provides sufficient tolerance in the x, z plane so that nearly all the flux can be coupled.

For embodiments where the collimating optic is a solid dielectric and is in direct contact with the LED or other light sources, there are two preferred ways to couple the parts. In the first case, where there is a wire-bond protruding from the chip of the LED package, the base of the concentrating optic should be manufactured with a gap that surrounds the wire. A clearance of 50 microns in the vertical height direction is typically sufficient. In addition, there should be a concave void at the base of the optic such that it can be filled with a suitable index-matching liquid, gel or adhesive. Index-matching fluids are available from Cargille Laboratories, of New Jersey. A suitable material from this company is their “LASER LIQUIDS” product line. If a solid bond is required, a gel or a low-durometer UV-cured adhesive can be employed. Suitable gels for the application are available from a number of sources, including Nye Optics of Massachusetts, Dow Corning of Michigan, and Nusil of California. Suitable low-durometer UV-curing adhesives are available from Dymax of Connecticut, with a durometer as low as 0040. In the second case, where there is no wire-bond, the notch in the optic can be eliminated and only the concave void is needed. As in the other case the void is filled with an index-matching liquid, a gel, or a low-durometer adhesive.

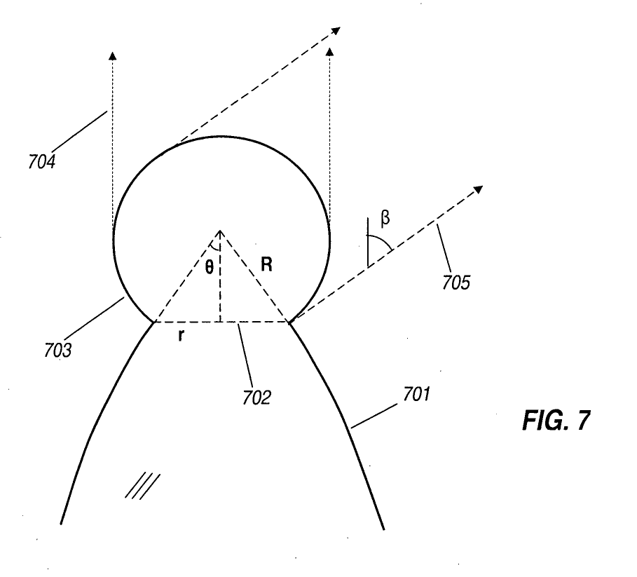

In these embodiments, the spherical deployment of the remote phosphor material increases its area relative to that of the exit aperture of the concentrator. FIG. 7 shows a close-up diagram of a generic spherical phosphor configuration, with the lower part of the profile of concentrator 701 terminating at exit aperture 702, of radius r. Radius r subtends the angle θ from the center of spherical surface 703, of radius R, so that r=R sin θ, and the output area of the concentrator is A_{O}=πr². The remote phosphor (too thin to be visible) coats the outside of spherical surface 703, and thereby receives the light that concentrator 701 sends through aperture 702. One of the properties of the sphere is that an elemental Lambertian radiator on its inside surface will generate uniform irradiance on the rest of the inside surface, because the change in the viewing angle exactly compensates for the distance to the radiator from any viewpoint. Therefore if concentrator 701 produces uniform illumination upon aperture 702 then spherical surface 703 will be uniformly illuminated as well. Reinforcing this uniformity is the fact that both the blue light scattered by the phosphor and the yellow light stimulated by its absorption will divide between outwards emission and return emission back into the concentrator. The ratio of this outward white emission to the blue light delivered by the concentrator is the previously discussed P_{T}. The fraction returned to concentrator 701 is (1−P_{T}), and must be recovered by some recycling means. The spherical phosphor of the present devices acts to greatly increase P_{T}.

A flat remote phosphor across exit aperture 702 will typically send more back into concentrator 701 than outwards. A phosphor on the outside of spherical surface 702 has strong back emission as well, but most of it shines elsewhere on the phosphor, acting as a kind of recycling. The fraction of this that goes back into aperture 702 equals the ratio of exit area A_{O} to phosphor sphere area A_{P}, as given by

$$\frac{{A}_{O}}{{A}_{P}} = \frac{{sin}^{2} ϑ}{2 {( 1 + cos ϑ )}^{2}}$$

In FIG. 7; this fraction is only 11%, considerably less than the 50% of a hemisphere. It must be remembered that the increased area of surface 703 over exit aperture 702 causes the phosphor luminance to be reduced by this amount as well, but the benefits are better spherical emission and increased efficiency.

FIG. 7 shows that a glowing phosphor on surface 703 will have constant intensity from the on-axis direction, represented by rays 704, to the off-axis angle β=90−θ, represented by rays 705. At greater off-axis angles intensity falls off very slowly, and only until nearly downward angles does it go under half the on-axis intensity. This is close to the nearly spherical emission of a conventional light bulb, enabling reasonable functional substitution. The small amount of radiation from the outside of surface 703 that re-enters the concentrator 701 from the outside will mostly pass through the concentrator and exit, merely adding a gleam to its appearance.

The deployment of a remote phosphor on a spherical surface will also increase the efficiency P_{T} over that of a flat phosphor deployed on the concentrator exit plane. The P_{T} of a flat remote phosphor is a complicated function of its thickness and the scattering coefficient of the phosphor layer, as well as the absorptivity, quantum efficiency, and Stokes' shift of the phosphor's photoluminescent component. The absorptivity is proportional to the concentration of the photoluminescent component and can thus be slightly altered, while the last two factors are fixed for any given phosphor formulation, so that only layer thickness and scattering coefficient can be tailored to a specific situation, but they too are constrained by the color-balance requirement that about one quarter of the output light be blue, with the rest converted to yellow. The previously discussed important parameter, the fraction P_{T} of the blue input that is output, as blue or yellow light, without any recycling, is between 0.15 and 0.3 for a typical flat remote phosphor that produces white light.

The light output of the phosphor ball is

$${P}_{TB} = \frac{{P}_{T}}{1 - ( 1 - \frac{{A}_{O}}{{A}_{P}} ) ( 1 - {P}_{T} )} = \frac{{A}_{P} {P}_{T}}{{A}_{O} ( 1 - {P}_{T} ) + {A}_{P} {P}_{T}}$$

The light returned to the optic by the phosphor ball is

$${P}_{OB} = \frac{\frac{{A}_{O}}{{A}_{P}} ( 1 - {P}_{T} )}{1 - ( 1 - \frac{{A}_{O}}{{A}_{P}} ) ( 1 - {P}_{T} )} = \frac{{A}_{O} ( 1 - {P}_{T} )}{{A}_{O} ( 1 - {P}_{T} ) + {A}_{P} {P}_{T}}$$

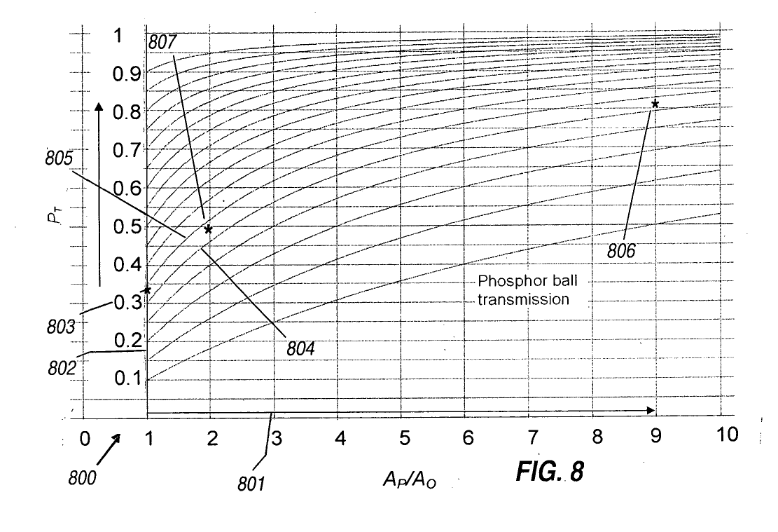

FIG. 8 shows graph 800 with abscissa 801 for the ratio of area A_{P}, relative to a flat surface of area A_{O}, and ordinate 802 for the P_{TB} of the spherical remote phosphor. The curves show how P_{TB} varies with A_{P}/A_{O} for given values of P_{T} and with the same phosphor material and thickness throughout. The ordinate value of P_{TB} for each curve on the ordinate axis at A_{P}/A_{O}=1 is equal to P_{T}, and gives the output value a flat phosphor across the exit aperture 702 would have. Operating point 803 is at the ⅓ point, lying between curve 804 for P_{T}=0.3 and 805 for P_{T}=0.35, at an abscissa of 1 (flat phosphor). An abscissa of A_{P}/A_{O}=9, corresponding to the configuration of FIG. 6, moves the system to operating point 806, for P_{T}=80%. This greatly reduces the required efficiency of recycling, which must be very high when P_{T} is as low as it is for the typical flat remote phosphor. This and the good spherical emission are reasons for the present devices. A hemisphere, at the abscissa 2, has operating point 807, about 50% efficiency. The lateral emission of a hemispheric remote phosphor is half of the axial forward emission, with only a small amount below horizontal.

In order to ascertain the accuracy of the aforementioned equations, the inventors performed a number of ray tracing simulations, in which two different optical configurations were modeled. The first was that shown in FIG. 5A. The exit aperture was reduced by a factor of n², relative to the entrance aperture, where n is the index of refraction of the concentrator optic. The optic was assumed to be of acrylic, n=1.495 in the middle of the visible spectrum. The second optical configuration used circular symmetric solid dielectric CPCs with a short pass filter attached to the large end. Each CPC was a mirror image of the other. The entrance and exit apertures were the same size in this configuration. For each optical configuration six cases were modeled. Three cases were for a square source, the other three round. The source in each case either filled the entrance aperture of the collimating optic (in the round case) or touched its boundary at four points (the case of the square source). Finally, there were three types of phosphor emitter modeled: a flat phosphor patch, a hemispherical ball with a phosphor patch covering the outside surface, and a larger ball with an opening angle, as shown in FIG. 5A. The phosphor thickness and bulk scattering coefficient were assumed to be constant, at respectively 100 microns thickness and 100/mm. The ray tracing package TracePro 4.1 was used to calculate the amount of flux that escaped on the first pass. Any light recycled in the system was absorbed. These models provided a reasonable approximation of the value of P_{T}, although without taking into account phosphor-conversion losses (quantum efficiency and Stokes shift losses).

It was determined that the above simple equation for the change in P_{T} as a function of the ratio of the surface areas, was in excellent agreement with the ray-trace models, typically within 5 and 10%. For example, for the optical system of FIG. 5A, the values of P_{T} for the three cases of a square source were 0.22 for the flat phosphor, 0.34 for the hemisphere phosphor and 0.78 for the larger spherical phosphor ball. Starting with a value for the flat phosphor case of 0.22, the equation predicts that the value of P_{T} should increase to 0.36 (for a doubling of the surface area of the phosphor). For the larger phosphor ball case (approximately twenty times increase in surface area), the equation yields a value of 0.85 or approximately 10% higher than the raytrace simulation.

The ray-trace simulations also confirmed that the phosphor ball (hemisphere and larger phosphor sphere) configurations homogenized the output for the square source such that there was no asymmetry in the intensity plots around the longitudinal axis of the optical system. That is to say, the output symmetry was nearly identical for the round and square sources. The opportunity to achieve that symmetry is an important advantage of certain embodiments of the present devices, and makes them eminently suitable for use as a replacement source for incandescent filaments.

The preceding description of the presently contemplated best mode of practicing the invention is not to be taken in a limiting sense, but is made merely for the purpose of describing the general principles of the invention. The full scope of the invention should be determined with reference to the Claims.

In the interests of clarity certain of the embodiments have been described with reference to the orientation in which they are shown in the drawings. However, those embodiments can, and frequently will, be used in other orientations, and the orientations described are merely illustrative and not limiting.

We claim:

1. A light source comprising:
an emitter of photostimulative light;
a reflector disposed about said emitter so as to reflect light from said emitter towards an outlet end;
a tailored aspheric lens that further collimates the light from said reflector;
a short-pass filter receiving said collimated light and transmitting light from said emitter;
a dielectric concentrator on the other side of said filter, said concentrator receiving said transmitted light and concentrating said light on an exit aperture;
a dielectric emitting optic on the outside of said exit aperture so as to receive said concentrated light; and
a layer of photosensitive phosphor deposited on the outside of said dielectric emission optic, said photosensitive phosphor responsive to said photostimulative light to emit light of a longer wavelength.

2. The light source of claim 1, wherein the emitter of photostimulative light comprises one or more light-emitting diodes.

3. The light source of claim 1, wherein said emitter emits blue light, said short-pass filter is a blue pass filter, and said photosensitive phosphor emits yellow light.

4. The light source of claim 1, wherein said reflector is a collimator.

5. The light source of claim 1, wherein said reflector is conical.

6. The light source of claim 1, wherein the exit aperture is smaller than an effective light-emitting surface of the emitter.

7. The light source of claim 1, said concentrator being rotationally symmetric, with a profile comprising a frontal curve adjacent to said filter and a totally internally reflecting sidewall defining the length of said concentrator by extending from said frontal curve to said, dielectric emission optic, said sidewall having a curved profile tailored to reflect into said dielectric emission optic the edge rays from said reflector, said edge rays defined as those emitted by the edges of said emitter.

8. A light source comprising:
an emitter of photostimulative light;
an optical stage arranged to collect light from the emitter and forward collected light to an exit aperture;
a dielectric emitting optic on the outside of said exit aperture so as to receive said forwarded light; and
a layer of photosensitive phosphor deposited on the outside of said dielectric emission optic, said photosensitive phosphor responsive to said photostimulative light to emit light of a longer wavelength.

9. The light source of claim 8, further comprising a filter between said emitter and said exit aperture and spaced from said emitter, said filter transmitting light from said emitter to said exit aperture, and reflecting light from said phosphor back towards said exit aperture.

10. The light source of claim 9, wherein said optical stage further comprises a collimator between said emitter and said filter and a concentrator between said filter and said exit aperture.

11. The light source of claim 8, wherein said optical stage further comprises a conical reflector disposed about said one or more diodes so as to reflect light from said emitter towards said exit aperture and a tailored aspheric lens that further collimates the light from said reflector.

12. The light source of claim 8, wherein said optical stage further comprises a dielectric concentrator arranged to concentrate said light at said exit aperture, and said dielectric emission optic is optically continuous with said dielectric concentrator through said exit aperture.

13. The light source of claim 8, wherein the emitter of photostimulative light comprises one or more light-emitting diodes.

14. The light source of claim 8, wherein the exit aperture is smaller than an effective light-emitting surface of the emitter.

15. The light source of claim 10, wherein the concentrator is rotationally symmetric, with a profile comprising a frontal curve adjacent to said filter and a totally internally reflecting sidewall defining the length of said concentrator by extending from said frontal curve to said dielectric emission optic, said sidewall having a curved profile tailored to reflect into said dielectric emission optic the edge rays from said collimator, said edge rays defined as those emitted by the edges of said emitter.
